(19) United States
(12) Patent Application Publication
(10) Pub. No.: US 2024/0241846 A1
(43) Pub. Date: Jul. 18, 2024

(54) DIRECT MEMORY ACCESS DEVICE AND DATA PROCESSING SYSTEM USING THE SAME

(71) Applicant: NUVOTON TECHNOLOGY CORPORATION, HSINCHU CITY (TW)

(72) Inventors: Chang-Ta WU, Zhubei City (TW); Wei-Fan LIN, Zhubei City (TW)

(21) Appl. No.: 18/494,388

(22) Filed: Oct. 25, 2023

(30) Foreign Application Priority Data
Jan. 17, 2023 (TW) 112102072

(51) Int. Cl. G06F 13/28

(52) U.S. Cl. CPC G06F 13/28; G06F 2213/28

(57) ABSTRACT

A direct memory access device has a first channel combination/separation unit, a second channel combination/separation unit and a data processing device. The first channel combination/separation unit selectively combines/separates channels of data received by the direct memory access device. The second channel combination/separation unit selectively combines/separates channels of data processed by the data processing device. The data are then output by the direct memory access device. The data processing device receives a data output by the first channel combination/separation unit. The data processing device is used to selectively perform at least one of amplification/down-scale process, data bit number adjustment process and shifting process on its received data, and output the data to the second channel combination/separation unit. A sequence and each number of the above-mentioned multiple processes are determined by control selection commands.

### CROSS-REFERENCE TO RELATED APPLICATION

This application claims the priority from the TW Patent Application No. 112102072, filed on Jan. 17, 2022, and all contents of such TW Patent Application are comprised in the present disclosure.

### BACKGROUND

### 1. Field of the Invention

The present disclosure relates to a direct memory access device, in particular to, a direct memory access device and a data processing system using the same can combine/separate channels, and perform an amplification process, a data bit number adjustment process and a shifting process on data during migrating data process.

### 2. Description of the Related Art

The pulse code modulation data of the audio stream from the memory of the source device needs to perform the mono/multi-channel process, shifting process and data bit number adjustment process. Further, the data bit number adjustment process is, for example, a data range adjustment process. These aforementioned processes are performed by a central processing unit or a digital signal processing unit in the back stage. Then, the processed data is transmitted to the memory of the destination device for storing after the pulse code modulation data of the audio stream is processed by the central processing unit or the digital signal processing unit. From the above description, we can know that these above-mentioned processes need to match the types of the source device and the destination device, so that there are many restrictions in the application and there is less flexibility. Also, it also consumes the computation time of the central processing unit or the digital signal processing unit.

The direct memory access device is an interface device that the destination device skips the control of the central processing unit and directly accesses data on the source device. For example, when the destination device is a display card, a sound card or a machine learning device, this destination device reads the data of the source device via the direct memory access device, and the processed data are stored into this destination device via the direct memory access device. The exiting direct memory access device is simply used as a cache device between the destination device and the source device. The exiting direct memory access device does not perform other process on the data, and the process of the data is performed by the destination device.

However, the demand for the data process is increasing at present, for example, the demands for clearer and more realistic audio-video media and big data machine learning. The data obtained from the memory is usually unavoidably subjected to at least one of the amplification/down-scale process, the data bit adjustment process and the shifting process. Therefore, it is necessary to design the destination device to be able to achieve the above-mentioned multiple processes. However, it leads to increase the computation load of the destination device or leads to a larger hardware circuit of the destination device. Furthermore, the above-mentioned manners also increase the time for the destination device processing data. Consequently, it is necessary to provide a direct memory access device to solve the above technical problems.

### SUMMARY

It can be understood from the above descriptions that the technical problems to be solved in embodiments of the present disclosure is to reduce the hardware circuit, computation load and processing time of the destination device connected to the direct memory access device in the data processing system. Further, the types of the source device and the destination device do not be limited.

In order to solve the above-mentioned conventional problems, an embodiment of the present disclosure provides a direct memory access device. The direct memory access device comprises a first channel combination/separation unit, a data processing device and a second channel combination/separation unit. The data processing device is electrically connected to the first channel combination/separation unit and the second channel combination/separation unit. The first channel combination/separation unit is configured to receive first data of a source device, and to maintain or change a first channel number of the first data to output second data. The data processing device is configured to receive the second data. The data processing device is configured to selectively perform at least one of the amplification/down-scale process, the data bit number adjustment process and the shifting process on the second data to generate third data. A sequence and each number of the amplification/down-scale process, the data bit number adjustment process and the shifting process and execution times of each the amplification/down-scale process, data bit number adjustment process and the shifting process are determined by a control selection command. The second channel combination/separation unit is configured to receive the third data, and to maintain or change a second channel number of the third data to output fourth data to a destination device.

In order to solve the above-mentioned conventional problems, an embodiment of the present disclosure further provides a data processing system. The data processing system comprises the aforementioned direct memory access device, the source device and the destination device.

To sum up, the direct memory access device and the data processing system provided by the embodiments of the present disclosure can increase the processing speed of the destination device connected to the direct memory access device. As well, the size and cost of the destination device connected to the direct memory access device can be reduced. Furthermore, the direct memory access device and the data processing system also have higher flexibility, so that the direct memory access device and the data processing system can be used for various types of the source devices and the destination devices.

### BRIEF DESCRIPTION OF THE DRAWINGS

In order to make the above-mentioned and other purposes, features, advantages and embodiments of the present disclosure more obvious and understandable, and the accompanying drawings are described as follows.

FIG. 1 is a block diagram of a data processing system according to an embodiment of the present disclosure; and

FIG. 2 is a block diagram of a data processing system according to another embodiment of the present disclosure.

### DESCRIPTION OF THE PREFERRED EMBODIMENTS

Embodiments of the present disclosure provide a direct memory access device. The direct memory access device at least comprises the first channel combination/separation unit, the second channel combination/separation unit and the data processing device. The first channel combination/separation unit selectively combines/separates channels on the received data from the direct memory access device. The second channel combination/separation unit selectively combines/separates channels on the data processed by the data processing device. The data are output by the direct memory access device. The data processing device receives the data output by the first channel combination/separation unit. The data processing device is configured to selectively perform at least one of the amplification/down-scale process, the data bit number adjustment process and the shifting processing on the received data. Then, the data processing device outputs the processed data to the second channel combination/separation unit. The sequence and each number of the above-mentioned processes are determined by a control selection command.

Based on the above manners, it is possible to reduce the need for the destination device to perform the channel combination/separation, amplification process, data bit number adjustment process and shifting process. Thus, the hardware cost and computation time of the destination device can be reduced. Moreover, the sequence and each number of the multiple processes can be determined by the control selection command. The first channel combination/separation unit and the second channel combination/separation unit selectively combine/separate channels based on the data formats of the source device and the destination device respectively. Therefore, the direct memory access device of the embodiments of the present disclosure has no limitation on the types of the source devices and the destination devices, so that the flexibility of the application is increased.

The following descriptions are taking the data stored in the source device as an audio data of an audio stream, such as a pulse code modulation data of the audio stream, and the destination device as a player chip as an example. The first channel combination/separation unit adjusts or maintains the original channel number of the audio data received from the source device based on the application requirements, for example, mono-channel audio data become multi-channel audio data, or multi-channel audio data become mono-channel audio data. The second channel combination/separation unit adjusts and maintains the original channel number of the audio data received from the data processing device based on the type of the destination device. The data processing device performs at least one of the amplification/down-scale process, the data bit number adjustment process and the shifting process on the audio data received from the first channel combination/separation unit. The sequence and each number of the above-mentioned multiple processes are determined by the control selection command. For example, for the audio data, the data bit number adjustment process is performed first, the amplification process and the right-shifting process is proceeded next, and then the amplification process is performed again. Alternatively, for the audio data, amplification is processed first and then the left-shifting process is performed.

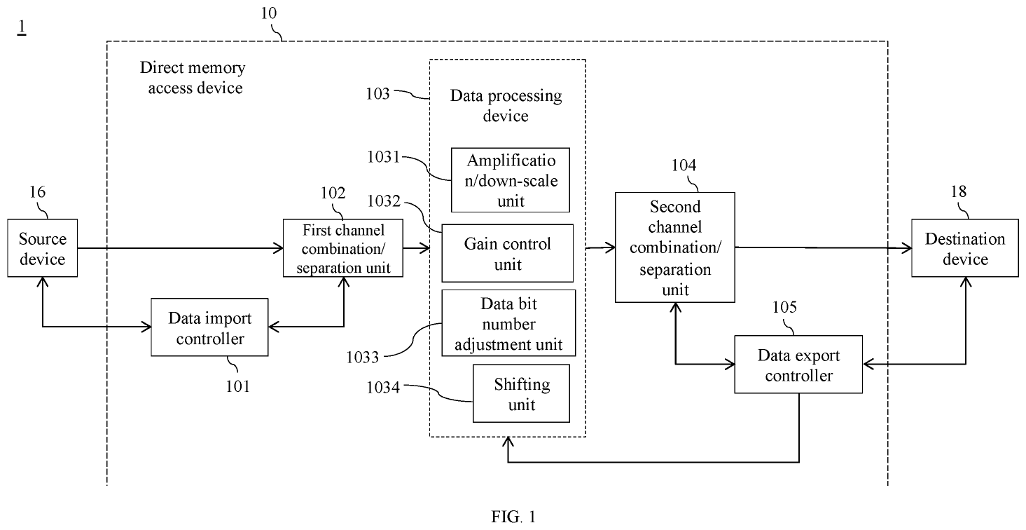

Firstly, please refer to FIG. 1, FIG. 1 is a block diagram of a data processing system according to an embodiment of the present disclosure. The direct memory access device 10 at least comprises the first channel combination/separation unit 102, the data processing device 103 and the second channel combination/separation unit 104. The data processing device 103 is electrically connected to the first channel combination/separation unit 102 and the second channel combination/separation unit 104. The first channel combination/separation unit 102 is configured to receive the first data of the source device 16. The first channel combination/separation unit 102 is configured to maintain or change the first channel number of the first data to output the second data. The data processing device 103 is configured to receive the second data. The data processing device 103 is configured to selectively perform at least one of the amplification/down-scale process, the data bit number adjustment process and the shifting process on the second data to generate the third data. The sequence and each number of the amplification/down-scale process, the data bit number adjustment process and the shifting process and execution times of each the amplification/down-scale process, data bit number adjustment process and the shifting process are determined by the control selection command. Further, the number of the amplification/down-scale process, the data bit number adjustment process and the shifting process is usually one. The second channel combination/separation unit 104 is configured to receive the third data. The second channel combination/separation unit 104 is configured to maintain or change the second channel number of the third data to output the fourth data to the destination device 18. For example, when it is necessary to perform data bit number adjustment process, the sequence of the multiple processes may be to perform the data bit number process first and then perform the amplification/down-scale process, or the sequence of the multiple processes may be to perform the amplification/down-scale process first and then perform the data bit number process.

In this embodiment, the direct memory access device 10 further comprises the data import controller 101 and the data export controller 105. The data import controller 101 is electrically connected to the first channel combination/separation unit 102 and the source device 16. The data export controller 105 is electrically connected to the second channel combination/separation unit 104 and the destination device 18. The data import controller 101 is configured to control the source device 16 to import the first data into the first channel combination/separation unit 102. The data export controller 105 is configured to control the destination device 18 to export the fourth data from the second channel combination/separation unit 102. The data export controller 105 is configured to generate a count trigger signal to the data processing device 103 to make the data processing device 103 count a migration number of the fourth data. Moreover, the migration number of the fourth data is equal to a migration number of the data exported from the source device 16 and imported into the direct memory access device 10.

Further, in this embodiment of the present disclosure, the data processing device 103 comprises the amplification/down-scale unit 1031, the gain control unit 1032, the data bit number adjustment unit 1033 and the shifting unit 1034. The amplification/down-scale unit 1031 is configured to amplify/scale-down the second data based on a gain. The gain control unit 1032 is electrically connected to the amplification/down-scale unit 1031 and the data export controller 105. The gain control unit 1032 determines whether the automatic control gain of the amplification/down-scale unit 1031 is changed based on the migration number. Moreover, after the gain control unit 1032 is triggered, the gain control unit 1032 determines that the gain is increased or decreased by a specific gain based on the comparison result between the current gain of the amplification/down-scale unit 1031 and a target gain, or based on the comparison result between the intensity of the processed second data and a target intensity. For example, the specific gain is 1, and the present disclosure is not limited thereto. That is, the gain control unit 1032 utilizes the migration number as a reference to amplify/scale-down each stage of the second data, so that the gain for the amplification/down-scale process can increase and decrease automatically, and the speed of the volume change can be adjusted based on the migration number. The data bit number adjustment unit 1033 is configured to adjust the bit number of the second data, that is, to adjust the range of the second data. Usually, the bit number is adjusted only when the requirement for the data bit number of the first data is different from the requirement for the data bit number of the fourth data. For example, 32-bit is reduced to 16-bit, or 16-bit is changed to 32-bit, and the present disclosure is not limited thereto. For example, the data bit number adjustment unit 1033 may perform a data range conversion of 16/24/32-bit. The shifting unit 1034 is configured to perform a right-shifting or a left-shifting of at least zero bit on the second data, for example, perform a 2-bit right-shifting on the second data. The shifting process is usually performed when the requirement for the bit length of the first data is different from the requirement for the bit length of the fourth data. It should be noted that the result of data bit number adjustment is different from the result of the shifting process for various type data. Thus, the data bit number adjustment unit 1033 and the shifting unit 1034 are designed in this embodiment.

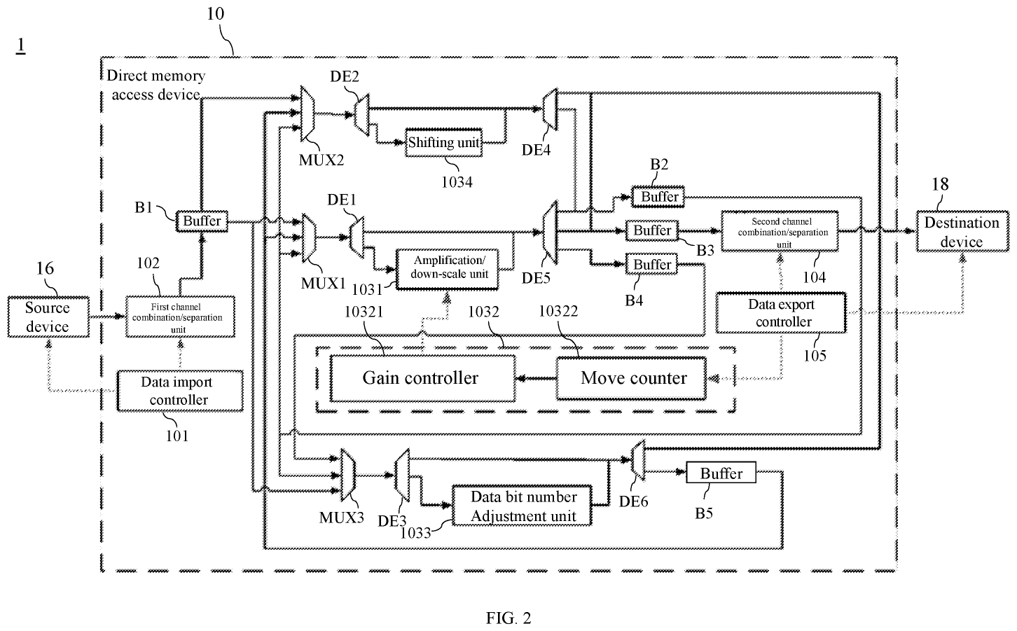

Next, please refer to FIG. 2, FIG. 2 is a block diagram of a data processing system according to another embodiment of the present disclosure. The data processing device 103 further comprises a route device. The route device comprises a plurality of multiplexers MUX1˜MUX3, a plurality of demultiplexers DE1˜DE6 and a plurality of buffers B1˜B5. The route device is electrically connected to the first channel combination/separation unit 102, the second channel combination/separation unit 104, the amplification/down-scale unit 1031, the data bit number adjustment unit 1033 and the shifting unit 1034. The route device is configured to control a data flow path of the second data based on the control selection command to determine the sequence and each number of the amplification/down-scale process, the data bit number adjustment process and the shifting process.

In addition, the gain control unit 1032 further comprises the migration counter 10322 and the gain controller 10321. The migration counter 10322 is electrically connected to the data export controller 105. The migration counter 10322 receives the count trigger signal to count the migration number of the fourth number. Furthermore, the migration counter 10322 outputs a gain-control triggering signal and resets the migration number when the migration number is counted to a predetermined number. The gain controller 10321 is electrically connected to the migration counter 10322. The gain controller 10321 is triggered based on the gain-control triggering signal. After the gain controller 10321 is triggered, the gain controller 10321 determines that the gain is increased or decreased by the specific gain based on the comparison result between the current gain of the amplification/down-scale unit 1031 and the target gain or based on the comparison result between the intensity of the processed second data and the target intensity. The gain control unit 1032 may select the comparison result about the gain or the comparison result about the intensity to change the gain based on the control selection command.

Further, the buffer B1 is electrically connected to the first channel combination/separation unit 102 and the multiplexer MUX2 to receive the second data. The second data output by the buffer B1 are transmitted to the multiplexer MUX2. The multiplexer MUX2 is electrically connected to the buffer B5, the demultiplexer DE2 and the buffer B2 to output the second data from one of the buffers B5, B2 and B1 to the demultiplexer DE2 based on the control selection command. The demultiplexer DE2 is electrically connected to the shifting unit 1034 and the demultiplexer DE4 to transmit the second data from the multiplexer MUX2 to one of the shifting unit 1034 and the demultiplexer DE4 based on the control selection command. The demultiplexer DE4 is electrically connected to the shifting unit 1034, the buffers B3 and B2 to transmit the received second data to one of the buffers B3 and B2 based on the control selection command.

The multiplexer MUX1 is electrically connected to the buffers B1, B2, B5 and the demultiplexer DE1 to output the second data from one of the buffers B1, B2 and B5 to the demultiplexer DE1 based on the control selection command. The demultiplexer DE1 is electrically connected to the amplification/down-scale unit 1031 and demultiplexer DE5 to transmit the second data from the multiplexer MUX1 to one of the amplification/down-scale unit 1031 and the demultiplexer DE5 based on the control selection command. The demultiplexer DE5 is electrically connected to the amplification/down-scale unit 1031, the buffers B3, B2 and B4 to transmit the received second data to one of the buffers B3, B2 and B4 based on the control selection command. The buffer B3 is electrically connected to the second channel combination/separation unit 104. The buffer B3 is configured to transmit the stored second data as the third data to the second channel combination/separation unit 104.

The multiplexer MUX3 is electrically connected the buffers B1, B2, B4 and the demultiplexer DE3 to output the second data from one of the buffers B1, B2 and B4 to the demultiplexer DE3 based on the control selection command. The demultiplexer DE3 is electrically connected to the data bit number adjustment unit 1033 and the demultiplexer DE6 to transmit the second data from the multiplexer MUX3 to one of the data bit number adjustment unit 1033 and the demultiplexer DE6 based on the control selection command. The demultiplexer DE6 is electrically connected to the data bit number adjustment unit 1033, the buffers B3 and B5 to transmit the received second data to one of the buffers B3 and B5 based on the control selection command.

In this embodiment of the present disclosure, the direct memory access device 10 may be an audio direct memory access device. Each of the first channel combination/separation unit 102 and the second channel combination/separation unit 104 is a mono/multi-channel audio data conversion unit. The intensity of the amplified/scaled-down second data is a volume intensity, and the target intensity is a target volume intensity. The first data are first audio data, the second data are the second audio data, the third data are the third audio data, and the fourth data are the fourth audio data. The source device 16 may be a microphone module or a memory module for storing the first audio data. The destination device 18 may be an audio processing module, an audio processing chip or a memory module for storing the fourth audio data. The present disclosure is not limited to the above.

In another embodiment of the present disclosure, the direct memory access device 10 is a data conversion device of a big data processing server, that is, the destination device 18 itself is a machine learning device of the big data processing server. Each of the first channel combination/separation unit 102 and the second channel combination/separation unit 104 is a mono/multi-channel sensing data conversion unit. The source device 16 may store sensing data of the multi-channel or sensing data of the mono-channel, and the destination device 18 needs to use the sensing data of the multi-channel or the sensing data of the mono-channel. Therefore, the number of the channels of the sensing data needs to be adjusted. For example, the sensing data of the mono-channel is converted into the sensing data of the multi-channel, or the sensing data of the multi-channel is converted into the sensing data of the mono-channel. Moreover, the big data processing server is used to utilize the fourth data to proceed the machine learning.

According to the above description, because of the direct memory access device with the channel combination/separation process, the amplification/down-scale process, the data bit number adjustment process and the shifting, the computation time of the central processing unit and the digital signal processing unit can be saved. The expected data width and the expected volume of audio data can be obtained, wherein the data bit number is the expected bit number. The expected data width and the expected volume of audio data are convenient to be utilized for subsequent program or peripheral device. For other peripheral chips or devices in the microcontroller, there is no need to provide too many types of data formats of the audio data, so that the cost can be reduced. Furthermore, the format requirements for the audio data of the source device and the destination device can be flexibly converted into an appropriate format and docked with peripheral devices by using the direct memory access device. As a result, there is no limitation to the types of the source device and the destination device in application, so that the flexibility of the application can be improved.

It should be understood that the examples and embodiments described herein are for illustrative purpose only, and various modification or change in view of them will be suggested to those skilled in the art, and will be included in the spirit and scope of this application and the appendix within the scope of the claims.

What is claimed is:

1. A direct memory access device, comprising:
a first channel combination/separation unit, configured to receive first data of a source device, and maintain or change a first channel number of the first data to output second data;
a data processing device, electrically connected to the first channel combination/separation unit, and configured to selectively perform at least one of an amplification/down-scale process, a data bit number adjustment process and a shifting process on the second data to generate third data,
wherein an execution sequence of the amplification/down-scale process, data bit number adjustment process and the shifting process and execution times of each of the amplification/down-scale process, data bit number adjustment process and the shifting process are determined by a control selection command; and
a second channel combination/separation unit, electrically connected to the data processing device, configured to receive the third data, and maintain or change a second channel number of the third data to output fourth data to a destination device.

2. The direct memory access device according to claim 1, further comprising:
a data import controller, electrically connected to the first channel combination/separation unit and the source device, and configured to control the source device to import the first data into the first channel combination/separation unit; and
a data export controller, electrically connected to the second channel combination/separation unit and the destination device, configured to control the destination device to export the fourth data from the second channel combination/separation unit, and configured to generate a count trigger signal to the data processing device so that the data processing device counts a migration number of the fourth data.

3. The direct memory access device according to claim 2, wherein the data processing device comprises:
an amplification/down-scale unit, configured to amplify/scale-down the second data based on a gain;
a gain control unit, electrically connected to the amplification/down-scale unit and the data export controller,
wherein the migration number is configured to determine whether the gain control unit is triggered, and further to control the gain of the amplification/down-scale unit;
a data bit number adjustment unit, configured to adjust a data bit number of the second data; and
a shifting unit, configured to perform a right-shift or a left-shift of at least zero bit on the second data.

4. The direct memory access device according to claim 3, wherein after the gain control unit is triggered, the gain control unit adjusts the gain based on a comparison result between the gain and a target gain, or based on a comparison result between an intensity of the processed second data and a target intensity.

5. The direct memory access device according to claim 3, wherein the data processing device further comprises:
a route device, electrically connected to the first channel combination/separation unit, the second channel combination/separation unit, the amplification/down-scale unit, the data bit number adjustment unit and the shifting unit, and configured to control a data flow path of the second data to determine the sequence and execution times of the amplification/down-scale process, the data bit number adjustment process and the shifting process based on the control selection command.

6. The direct memory access device according to claim 5, wherein the route device comprises a plurality of multiplexers, a plurality of demultiplexers and a plurality of buffers.

7. The direct memory access device according to claim 4, wherein the gain control unit further comprises:
a migration counter, electrically connected to the data export controller, and configured to receive the count trigger signal to count the migration number of the fourth data,
wherein when the migration number is counted to a predetermined number, the migration counter outputs a gain-control triggering signal and resets the migration number; and
a gain controller, electrically connected to the migration counter,
wherein the gain controller is triggered based on the gain-control triggering signal, and
wherein after the gain-control triggering signal is triggered, the gain is adjusted based on the comparison result between the gain of the amplification/down-scale unit and the target gain, or based on the comparison result between the intensity of the second data after the amplification/down-scale process and the target intensity.

8. The direct memory access device according to claim 4, wherein the direct memory access device is an audio direct memory access device,
wherein each of the first channel combination/separation unit and the second combination/separation unit is a mono/multi-channel audio data conversion unit,
wherein the intensity is a volume intensity, and the target intensity is a target volume intensity, and
wherein the first data are first audio data, the second data are second audio data, the third data are third audio data, and the fourth data are fourth audio data.

9. The direct memory access device according to claim 1, wherein the direct memory access device is a data conversion device of a big data processing server,
wherein each of the first channel combination/separation unit and the second channel combination/separation unit is a mono/multi-channel sensing data conversion unit, and
wherein the big data processing server is configured to utilize the fourth data to proceed a machine learning.

10. A data processing system, comprising:
a direct memory access device, comprising:
a first channel combination/separation unit, configured to receive first data of a source device, and maintain or change a first channel number of the first data to output second data;
a data processing device, electrically connected to the first channel combination/separation unit, and configured to selectively perform at least one of an amplification/down-scale process, a data bit number adjustment process and a shifting process on the second data to generate third data,
wherein a sequence and each number of the amplification/down-scale process, data bit number adjustment process and the shifting process and execution times of each of the amplification/down-scale process, data bit number adjustment process and the shifting process are determined by a control selection command; and
a second channel combination/separation unit, electrically connected to the data processing device, configured to receive the third data, and maintain or change a second channel number of the third data to output fourth data to a destination device;
the source device; and
the destination device.

11. The data processing system according to claim 10, wherein the direct memory access device further comprises:
a data import controller, electrically connected to the first channel combination/separation unit and the source device, and configured to control the source device to import the first data into the first channel combination/separation unit; and
a data export controller, electrically connected to the second channel combination/separation unit and the destination device, configured to control the destination device to export the fourth data from the second channel combination/separation unit, and configured to generate a count trigger signal to the data processing device so that the data processing device counts a migration number of the fourth data.

12. The data processing system according to claim 11, wherein the data processing device comprises:
an amplification/down-scale unit, configured to amplify/scale-down the second data based on a gain;
a gain control unit, electrically connected to the amplification/down-scale unit and the data export controller,
wherein the migration number is configured to determine whether to the gain control unit is triggered, and further to control the gain of the amplification/down-scale unit;
a data bit number adjustment unit, configured to adjust a data bit number of the second data; and
a shifting unit, configured to perform a right-shift or a left-shift of at least zero bit on the second data.

13. The data processing system according to claim 12, wherein after the gain control unit is triggered, the gain is adjusted based on a comparison result between the gain of the amplification/down-scale unit and a target gain, based on a comparison result between an intensity of the second data after the amplification/down-scale process and a target intensity.

14. The data processing system according to claim 12, wherein the data processing device further comprises:
a route device, electrically connected to the first channel combination/separation unit, the second channel combination/separation unit, the amplification/down-scale unit, the data bit number adjustment unit and the shifting unit, and configured to control a data flow path of the second data to determine the sequence and each number of the amplification/down-scale process, the data bit number adjustment process and the shifting process based on the control selection command.

15. The data processing system according to claim 14, wherein the route device comprises a plurality of multiplexers, a plurality of demultiplexers and a plurality of buffers.

16. The data processing system according to claim 13, wherein the gain control unit further comprises:
a migration counter, electrically connected to the data export controller, and configured to receive the count trigger signal to count the migration number of the fourth data,
wherein when the migration number is counted to a predetermined number, the migration counter outputs a gain-control triggering signal and resets the migration number; and
a gain controller, electrically connected to the migration counter,
wherein the gain controller is triggered based on the gain-control triggering signal, and
wherein after the gain-control triggering signal is triggered, the gain is adjusted based on the comparison result between the gain after the amplification/down-scale unit and the target gain, or based on the comparison result between the intensity of the second data after amplification/down-scale process and the target intensity.

17. The data processing system according to claim 13, wherein the direct memory access device is an audio direct memory access device,
wherein each of the first channel combination/separation unit and the second combination/separation unit is a mono/multi-channel audio data conversion unit,
wherein the intensity is a volume intensity, and the target intensity is a target volume intensity, and
wherein the first data are first audio data, the second data are second audio data, the third data are third audio data, and the fourth data are fourth audio data.

18. The data processing system according to claim 10, wherein the direct memory access device is a data conversion device of a big data processing server,
wherein each of the first channel combination/separation unit and the second channel combination/separation unit is a mono/multi-channel sensing data conversion unit, and
wherein the big data processing server is configured to utilize the fourth data to proceed a machine learning.
